(19) United States
(12) Patent Application Publication
(10) Pub. No.: US 2017/0360011 A1
(43) Pub. Date: Dec. 21, 2017

(54) LIGHTING SYSTEM FOR REPTILE AND REPTILE HABITAT INCLUDING THE SAME

(71) Applicants: SEOUL VIOSYS CO., LTD., Ansan-si (KR); SENSOR ELECTRONIC TECHNOLOGY, INC., Columbia, SC (US)

(72) Inventors: Emmanuel LAKIOS, Mount Sinai, NY (US); Max SHATALOV, Columbia, SC (US); Timothy BETTLES, Irmo, SC (US); Alex DOBRINSKY, Loudonville, NY (US)

(21) Appl. No.: 15/187,229

(22) Filed: Jun. 20, 2016

(51) Int. Cl. A01K 63/06; F21V 23/04

(52) U.S. Cl. CPC A01K 63/065; F21V 23/0457

(57) ABSTRACT

A lighting system includes an ultraviolet (UV) light source including a UVA light source configured to emit UVA light having various wavelengths; and a UVB light source configured to emit UVB light and control a lighting direction of the UVB light towards a target, a sensor including a UVA sensor configured to sense the UVA light, and a control unit configured to control lighting characteristics of the UV light source, in which the lighting characteristics include an intensity of the UVA light.

### BACKGROUND

### Field

Exemplary embodiments relate to a lighting system for reptile and a reptile habitat including the same, and more particularly, to a lighting system for reptile and a reptile habitat including the same capable of providing light for habitation and raising of reptile and facilitating maintenance.

### Discussion of the Background

Reptiles such as a lizard, a snake, a turtle, and a gecko have been raised as a pet or for display at a zoo, or the like. The reptiles have been generally raised at a space like a reptile tank (or cage) as a habitat. Since the reptiles raised as a pet or for display may live in a room or a case, where sunlight may not be entirely irradiated frequently, artificial light is generally required for the habitat of the reptiles.

Ultraviolet (UV) light is essential for the survival of reptiles (even in some amphibians). Reptiles may visually recognize ultraviolet A (UVA; about 320 nm to 400 nm) light and perform social communication between species using the UVA light. Therefore, UVA light is essential for visual recognition ability for the reptiles. Further, it is generally known that the UVA light affects a physiological pattern and a behavior pattern of the reptiles. In any species, UVA light generally affects a struggle, breeding, and signaling behavior of the reptiles. Ultraviolet B (UVB; about 280 nm to 320 nm) light generally affects nutritive conditions of the reptiles. For example, many kinds of reptiles use the UVB light to convert 7-dehydrocholesterol into vitamin D3 in the skin, and photobiogenesis of the vitamin D3 is essential for absorption and maintenance of calcium. Further, temperature, an irradiation period, intensity, or the like of the ultraviolet light may affect the behavior and physiology of the reptiles. Accordingly, appropriate irradiation of ultraviolet light has an important effect on the breeding, appetite, stress, or the like of the reptiles.

The above information disclosed in this Background section is only for enhancement of understanding of the background of the inventive concept, and, therefore, it may contain information that does not form the prior art that is already known in this country to a person of ordinary skill in the art.

### SUMMARY

Exemplary embodiments provide a lighting system for reptile and a reptile habitat including the same capable of sensing light in real time to irradiate appropriate light to a target (reptile, or the like), thereby optimally maintaining a lighting state.

Additional aspects will be set forth in the detailed description which follows, and, in part, will be apparent from the disclosure, or may be learned by practice of the inventive concept.

According to an exemplary embodiment of the present invention, a lighting system includes an ultraviolet (UV) light source including a UVA light source configured to emit UVA light having various wavelengths; and a UVB light source configured to emit UVB light and control a lighting direction of the UVB light towards a target, a sensor including a UVA sensor configured to sense the UVA light, and a control unit configured to control lighting characteristics of the UV light source, in which the lighting characteristics include an intensity of the UVA light.

According to an exemplary embodiment of the present invention, a habitat includes an enclosure, a lighting fixture configured to irradiate light to an internal space of the enclosure, a sensor, and a control unit. The lighting fixture includes an ultraviolet (UV) light source including a UVA light source including lighting elements configured to emit UVA light having various wavelengths, and a UVB light source configured to emit UVB light and control a lighting direction of the UVB light towards a target. The sensor includes a UVA sensor configured to sense the UVA light and the control unit is configured to control lighting characteristics of the UV light source, the lighting characteristics including an intensity of the UVA light emitted from the lighting elements.

According to an exemplary embodiment of the present invention, a lighting system for irradiating reptile habitat includes a multi-wavelength UV light source including UVA light sources each including at least one lighting element configured to emit UVA light having a wavelength greater than 330 nm, UVB light sources configured to emit UVB light and control a lighting direction of the UVB light towards a target, UVC light sources configured to irradiate UVC light towards surfaces of the reptile habitat, and a control unit configured to control lighting characteristics of the multi-wavelength UV light source, in which the lighting characteristics of the multi-wavelength UV light source include increasing or decreasing lighting intensity of the UVA, UVB, and UVC lights, decreasing lighting intensity includes turning off one or more of the UVA, UVB, and UVC light sources, and the intensity of UVC light and direction is selected and controlled not to induce damage to the reptiles present in the reptile habitat.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 is a block diagram illustrating a lighting system for reptiles according to an exemplary embodiment of the present invention.

FIG. 2 is a block diagram of a lighting system according to an exemplary embodiment of the present invention.

FIG. 3 is a block diagram of a lighting system according to an exemplary embodiment of the present invention.

FIG. 4 is a perspective view illustrating a reptile habitat including the lighting system according to an exemplary embodiment of the present invention.

FIG. 5 is a cross-sectional of a lighting fixture of a reptile habitat according to an exemplary embodiment of the present invention.

FIG. 6 is a cross-sectional view of a lighting fixture of a reptile habitat according to an exemplary embodiment of the present invention.

FIG. 7 is a cross-sectional view of a lighting fixture of a reptile habitat according to an exemplary embodiment of the present invention.

FIG. 8 is a cross-sectional view for describing a UVA light source according to an exemplary embodiment of the present invention.

FIG. 9 is a cross-sectional view of a UVA light source according an exemplary embodiment of the present invention.

FIG. 10 is a cross-sectional view of a UVB light source according to an exemplary embodiment of the present invention.

FIG. 11 is a perspective view illustrating a reptile habitat including a lighting system according to an exemplary embodiment of the present invention.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Various exemplary embodiments are described herein with reference to sectional illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not be construed as limited to the particular illustrated shapes of regions, but are to include deviations in shapes that result from, for instance, manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the drawings are schematic in nature and their shapes are not intended to illustrate the actual shape of a region of a device and are not intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

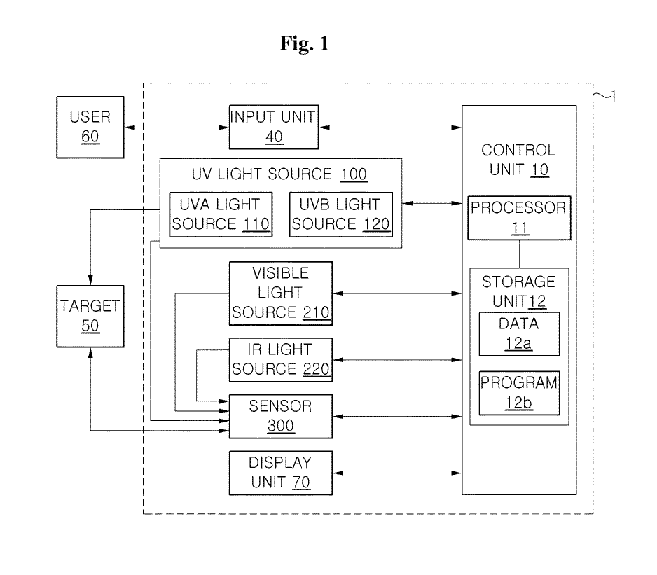

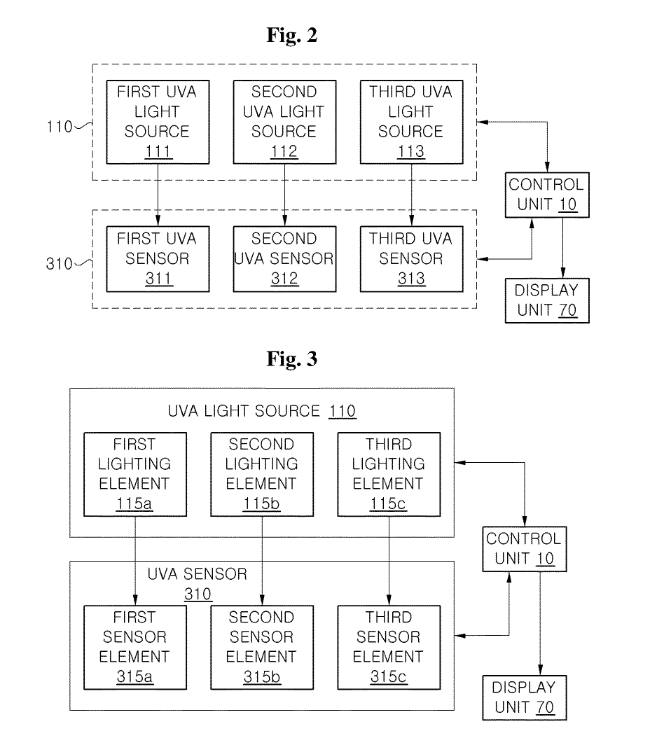

FIG. 1 is a block diagram illustrating a lighting system for reptiles according to an exemplary embodiment of the present invention. FIG. 2 is a block diagram of a lighting system according to an exemplary embodiment of the present invention. FIG. 3 is a block diagram of a lighting system according to an exemplary embodiment of the present invention.

Referring to FIG. 1, a lighting system 1 includes a control unit 10, a UV light source 100, and a sensor 300. The lighting system 1 may further include at least one of an input unit 40, a display unit 70, a visible light source 210, and an IR light source 220.

At least one of the input unit 40, the UV light source 100, the visible light source 210, the IR light source 220, the sensor 300, and the display unit 70 may be connected to the control unit 10 and may be controlled by the control unit 10.

According to the present exemplary embodiment, a target 50 to which light is irradiated by the lighting system 1 may include reptiles, such as a lizard, a snake, a turtle, and a gecko. The target 50 may also include various animals including amphibian, mammal, or the like. The target 50 may also include plants.

The control unit 10 may control various operations of the lighting system 1 and receive data or output various commands to other components. The control unit 10 may include a processor 11 and a storage unit 12.

The processor 11 may control the overall control unit 10 and perform an operation, processing, or the like on various data input to the control unit 10, and output commands for operating other components. For example, the processor 11 may output a command for controlling at least one of the UV light source 100, the visible light source 210, the IR light source 220, and the display unit 70, based on a series of data input from a user 60 and/or the sensor 300. This will be described below in more detail.

The storage unit 12 may include data 12a and a program 12b. Data 12a may include information previously input to a storage of the storage unit 12 or real-time input information during the operation of the lighting system 1. The data 12a may also include data input by the user 60. The program 12b may allow the processor 11 to perform predetermined commands and processes based on the data 12a input through predetermined solutions and algorithms.

According to the present exemplary embodiment, the data 12a may include control data of the light sources 100, 210, and 220 depending on the input of the user 60, control data of the light sources 100, 210, and 220 depending on the target 50, control data of the display unit 70, or the like. The data 12a may be converted into other mechanical languages through the predetermined solutions or algorithms of the program 12b that are transferred to the processor 11. More particularly, based on the information transferred from the storage unit 12, the processor 11 may control the light sources 100, 210, and 220, the display unit 70, and the sensor 300.

The light sources 100, 210, and 220 include the UV light source 100, the visible light source 210, and/or the IR light source 220.

The UV light source 100 may include the UVA light source 110 and the UVB light source 120. The UVA light source 110 and the UVB light source 120 may each include a general lamp, a light emitting diode, or the like. According to the present exemplary embodiment, the UVA light source 110 and the UVB light source 120 may each include at least one UV light emitting diode. The UVA light source 110 may emit UVA light having a wavelength range from about 320 nm to 400 nm. The UVB light source 120 may emit UVB light having a wavelength range from about 280 nm to 320 nm.

Lighting characteristics of light emitted from the UV light source 100 may be variously changed. The lighting characteristics may include at least one of a wavelength of the light emitted, a lighting intensity depending on the wavelength, a lighting spectrum of light, and an irradiation time of light. The lighting characteristics of light emitted from the UV light source 100, that is, the wavelength, intensity, spectrum, irradiation time, or the like of the light may be controlled by the control unit 10. The control unit 10 may control the lighting characteristics of light emitted from the UV light source 100 based on the data 12a of the storage unit 12 and the information acquired from the program 12b.

The UVA light source 110 may be controlled to provide an appropriate UVA illumination environment to the target 50. For example, the lighting characteristics of the UVA light source 110 are controlled depending on a species of the target 50, habitat environment in the wild, or the like. Daylight time at an original habitat (habitat in the wild) of the target 50, UVA wavelength characteristics of the daylight, or the like are stored in the storage unit 12 as the data 12a. The control unit 10 controls the lighting characteristics of the UVA light source 110 based on the data 12a. The UVA light source 110 may alternatively be operated to emit light having general UVA lighting characteristics, regardless of the species of the target 50. According to the present exemplary embodiment, when the lighting system 1 is applied to the habitat of reptiles (for example, reptile tank, reptile cage, or the like), the UVA light source 110 may supply light to the entire habitat. The UVA light may smoothen the visual recognition function of the target 50, such as the reptile, or the like. As such, the UVA light source 110 may be formed to supply light to the entire habitat.

The UVB light source 120 may be controlled to provide appropriate UVB illumination environment to the target 50. For example, the lighting characteristics of the UVB light source 120 are controlled depending on the species of the target 50, the habitat environment in the wild, or the like. Daylight time at the original habitat (habitat in the wild) of the target 50, UVB wavelength characteristics of the daylight, or the like are stored in the storage unit 12 as the data 12a. The control unit 10 controls the lighting characteristics of the UVB light source 120 based on the data 12a. The UVB light source 120 may alternatively be operated to emit light having general UVB lighting characteristics, regardless of the species of the target 50. According to the present exemplary embodiment, when the lighting system 1 is applied to the habitat of reptiles (for example, reptile tank, reptile cage, or the like), the UVB light source 120 may control the lighting direction of the UVB light towards the target 50, such that the UVB light is irradiated to the target 50. For example, the sensor 300 includes a sensing element (for example, infrared sensor) that may detect a position of the target 50, and transfers positional data of the target 50 to the control unit 10. The control unit 10 controls an area to which the UVB light is intensively provided by the UVB light source 120 based on the transferred positional data of the target 50. The UVB light may smoothen a nutritive condition keeping function of the target 50 such as the reptile, or the like. Accordingly, the light of the UVB light source 120 is irradiated towards the target 50, which may extend usage of the UVB light source 120 and reduce power consumption, due to the operation of the UVB light source 120. The UVB light source 120 may also be formed to provide the UVB light to the entire reptile habitat.

The light sources 100, 210, and 220 may further include the visible light source 210 and/or the IR light source 220. The visible light source 210 may emit light in a visible light wavelength range and the IR light source 220 may emit infrared light to supply thermal energy to the target 50 or into the habitat. The visible light source 210 and/or the IR light source 220 may be controlled by the control unit 10, and are controlled to provide the visible light and the infrared light to the habitat depending on the data 12a of the storage unit 12. Therefore, a suitable habitat environment for the target 50 or a desired environment chosen by the user 60 may be provided in the habitat.

The light sources 100, 210, and 220 may include the lighting elements that may be individually controlled to variously change the lighting characteristics of light emitted therefrom. Controlling at least one of the lighting characteristics of the light sources 100, 210, and 220 includes adjusting the lighting intensities of one or more lighting elements. For example, increasing and decreasing the lighting intensities of one or more lighting elements may include setting a turn on/off for one or more lighting elements.

For example, the UVA light source 110 may include lighting elements that may emit UVA light in a wavelength range of 320 nm to 400 nm, in which the lighting elements may have different peak wavelengths. The lighting elements having different peak wavelengths may include a UVA light emitting diode that has a peak wavelength, which has an approximately constant difference. The control unit 10 may increase and decrease the lighting intensities of the respective UVA light emitting diodes. For example, the UVA light source 110 may include first to ninth UV light emitting diodes, each having peak wavelengths of 320 nm, 325 nm, 330 nm, 340 nm, 350 nm, 360 nm, 370 nm, 385 nm, and 400 nm, respectively. The first to ninth UVA light emitting diodes may be individually controlled by the control unit 10, such that the intensity and the lighting spectrum depending on the wavelength of light emitted from the UVA light source 110 may be controlled. Similarly, the UVB light source 120 may include first to fourth UVB light emitting diodes each having peak wavelengths of 290 nm, 300 nm, 310 nm, and 320 nm, respectively. The first to fourth UVB light emitting diodes may be individually controlled by the control unit 10. Therefore, the intensity and the lighting spectrum depending on the wavelength of light emitted from the UVB light source 120 may be controlled. The visible light source 210 and/or the infrared light source 220 may also be controlled by the similar scheme with respect to the UVA light source 110 or the UVB light source 120 described above.

The lighting characteristics of the light sources 100, 210, and 220 may be variously controlled based on the adjustment of the lighting intensities of one or more lighting elements. The wavelength, the spectrum, the overall intensity of light, or the like may be controlled by controlling the lighting intensities of one or more lighting elements. As such, the lighting system 1 may provide light that is specialized for the target 50 without a complex solution or a complex circuit design. Further, the light emitting diodes may have a full width at half maximum (FWHM) narrower than general mercury-vapor lighting, or the like. As such, when the lighting elements include the UVA light emitting diodes or the UVB light emitting diodes having different peak wavelengths, the lighting characteristics of the UVA light source 110 or the UVB light source 120 may be easily controlled by controlling the lighting intensities of the respective light emitting diodes.

For example, the characteristics of UV light corresponding to the optimal habitat conditions may vary depending on the species of reptiles. According to the present exemplary embodiment, UV lighting characteristics of the lighting system 1 may be varied depending on the target 50, and thus, an occurrence of problems (for example, physiological problem) of the target 50 due to the deficiency, excess, mismatch, or the like of the UV light may be prevented.

The sensor 300 may sense at least some light emitted from the light sources 100, 210, and 220. The sensor 300 may further sense the position of the target 50. In addition, the sensor 300 may sense environmental conditions, such as temperature and humidity of the habitat.

According to the present exemplary embodiment, the sensor 300 may include a UVA sensor sensing the light emitted from the UVA light source 110. The UVA sensor may measure the spectrum of light emitted from the UVA light source 110 to sense the characteristics of light emitted from the UVA light source 110, so that the UVA sensor may provide a feedback to the control unit 10 for controlling the lighting characteristics. Further, when the UVA light source 110 includes lighting elements, the UVA sensor may sense the respective lighting elements. Data of the lighting characteristics sensed by the UVA sensor of the sensor 300 may be transferred to the control unit 10, and the control unit 10 may determine a defect in the UVA light source 110 based on the data of the lighting characteristics of the UVA light source 110. For example, if the UV light source 100 includes the UVA light sources 110, when some of the UVA light sources 110 are defective, the control unit 10 may inform the user 60 of the defective UVA light source 110 through the display unit 70, or the like. Alternatively, if the UVA light source 110 includes the lighting elements, when some of the lighting elements are defective, the control unit 10 may inform the user 60 of the defective lighting elements through the display unit 70, or the like. Therefore, the user 60 may replace the defective UVA light source 110 or the defective lighting element to prevent causing problems to the target 50 due to the defect of the UVA light source 110. Further, only the UVA light sources 110 or the lighting elements having defects may be replaced, which may reduce maintenance costs of the lighting system 1.

In detail, as illustrated in FIG. 2, the lighting system 1 may include UVA light sources 111, 112, and 113. According to the present exemplary embodiment, the UVA light source 110 may include a first UVA light source 111, a second UVA light source 112, and a third UVA light source 113. The first UVA light source 111, the second UVA light source 112, and the third UVA light source 113 may each emit UVA light having different wavelength ranges. For example, the first UVA light source 111 may emit UVA light having a wavelength ranging from about 320 nm to 345 nm, the second UVA light source 112 may emit UVA light having a wavelength ranging from about 345 nm to 370 nm, and the third UVA light source 113 may emit UVA light having a wavelength ranging from about 370 nm to 400 nm. The UVA sensor 310 may include first to third UVA sensors 311, 312, and 313. The first to third UVA sensors 311, 312, and 313 may each sense lighting characteristics of the first to third UVA light sources 111, 112, and 113. Therefore, the control unit 10 may identify a defect in the first to third UVA light sources 111, 112, and 113 by detecting the lighting characteristics of the first to third UVA light sources 111, 112, and 113, based on the reactivity of the first to third UVA sensors 311, 312, and 313. When at least one of the first to third UVA light sources 111, 112, and 113 is defective, the control unit 10 may display the defect on the display unit 70 and inform the user 60.

Referring to FIG. 3, according to an exemplary embodiment of the present invention, at least one UVA light source 110 may include lighting elements 115a, 115b, and 115c. The UVA light source 110 may include the first lighting element 115a, the second lighting element 115b, and the third lighting element 115c. The first to third lighting elements 115a, 115b, and 115c may each emit UVA light having different wavelength ranges. For example, the first lighting element 115a may emit UVA light having a wavelength ranging from about 320 nm to 345 nm, the second lighting element 115b may emit UVA light having a wavelength ranging from about 345 nm to 370 nm, and the third lighting element 115c may emit UVA light having a wavelength ranging from about 370 nm to 400 nm. The UVA sensor 310 may include first to third sensor elements 315a, 315b, and 315c. The first to third sensor elements 315a, 315b, and 315c may each sense lighting characteristics of the first to third lighting elements 115a, 115b, and 115c. Therefore, the control unit 10 may identify defects in the UVA light source 110 by detecting the lighting characteristics of the first to third lighting elements 115a, 115b, and 115c, depending on the reactivity of the first to third sensor elements 315a, 315b, and 315c. When at least one of the lighting elements of the UVA light source 110 is defective, the control unit 10 may display the defect on the display unit 70 and inform the user 60.

The user 60 may replace only the defective UVA light source (or defective lighting element), rather than replacing the entire UVA light sources, thereby easily replacing the UVA light source and reducing associated costs. Further, the UVA sensors (or the sensor elements) may each sense light having different wavelengths to identify defects, and therefore the lighting characteristics of the UVA light emitted from the lighting system 1 may be maintained as intended by the user 60. It is contemplated that the number of the UVA light sources or lighting elements may be varied.

According to an exemplary embodiment of the present invention, the sensor 300 may include a UVB sensor sensing light emitted from of the UVB light source 120. The sensor 300 may further include a visible light sensor sensing light emitted from the visible light source 210. Operations of the UVB sensor and the visible light sensor are substantially similar to that of the UVA sensor, and thus, repeated description thereof will be omitted.

According to an exemplary embodiment of the present invention, the sensor 300 may include a position detection sensor that may detect the position of the target 50. The position detection sensor may sense the movement of the target 50 or sense a body temperature of the target 50, to detect the position of the target 50. For example, the position detection sensor may include an infrared sensor. If the position of the target 50 is sensed by the position detection sensor, light from the UVB light source 120 may be irradiated to the target 50.

Further, the sensor 300 may include sensing elements that may sense factors for the habitat environment, such as a temperature, humidity, or the like. Therefore, the sensing elements may include a hygrometer, a thermometer, or the like.

The input unit 40 may input various data and commands according to the convenience of the user 60. A command input to the input unit 40 may be transferred to the control unit 10 as data. The input unit 40 may include a display and/or an input device. The display unit 70 may display a current state of the lighting system 1, and may display, for example, the lighting state of the light sources 100, 210, and 220, the temperature of the habitat, the humidity of the habitat, or the like. Further, in some exemplary embodiments, the input unit 40 and the display unit 70 may be integrated into a single device. For example, the lighting system 1 may include a touch screen, which may include the input unit 40 and the display unit 70.

Controlling the light sources 100, 210, and 220 by the control unit 10 may include retrieving the data 12a previously input by the user 60. The user 60 may input data to the control unit 10 to control the lighting characteristics of the UV light source 100, lighting characteristics of the visible light source 210, and lighting characteristics of the IR light source 220 depending on the target 50. For example, if the target 50 is a reptile, the user 60 inputs a command through the input unit 40 so that an environment similar to that of an original habitat of the target 50 may be created in a habitat. The control unit 10 controls at least one of the UV light source 100, the visible light source 210, and the IR light source 220 based on the data 12a corresponding to the input command. In this case, the UVA light source 110 emits UVA light, so that the UVA light may be substantially irradiated to the entire habitat, and the UVB light source 120 may control a lighting direction of the UVB light towards the target 50 depending on the detected position of the target 50.

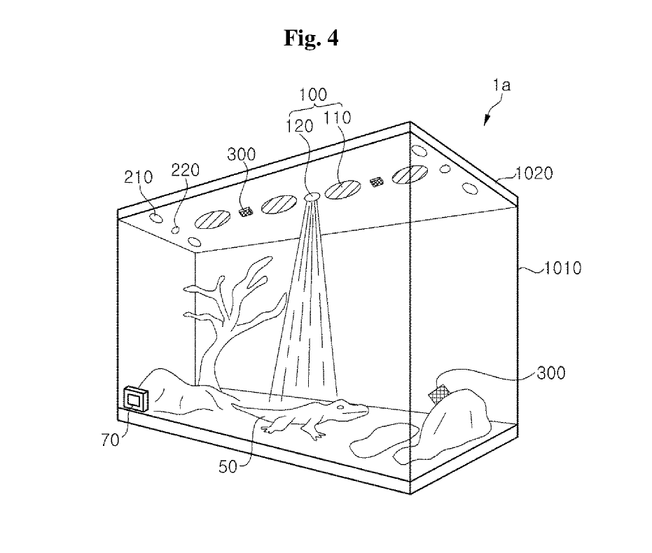

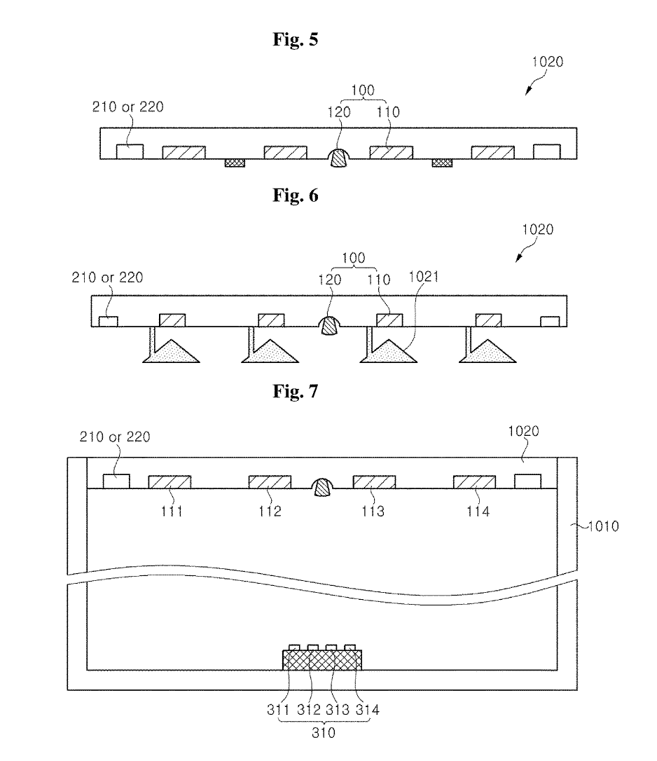

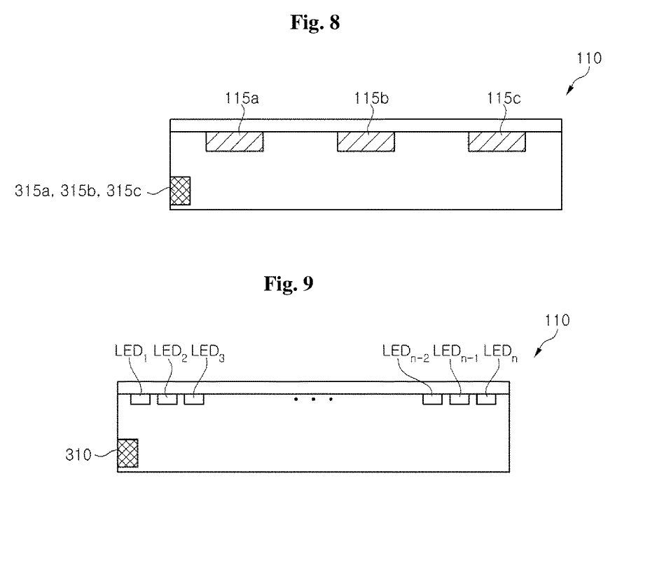

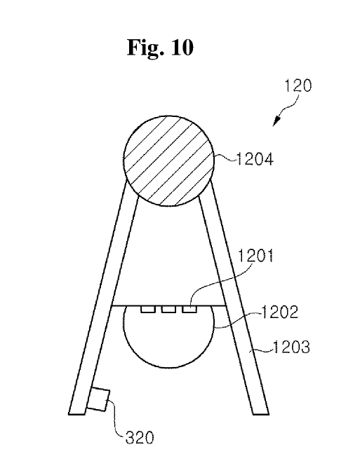

FIGS. 4 to 10 are diagrams for illustrating a reptile habitat including a lighting system according to exemplary embodiments of the present invention. FIG. 4 is a perspective view illustrating a reptile habitat according an exemplary embodiment of the present invention. FIG. 5 is a cross-sectional view of a lighting fixture of a reptile habitat according to an exemplary embodiment of the present invention, FIG. 6 is a cross-sectional view of a lighting fixture of a reptile habitat according to an exemplary embodiment of the present invention, and FIG. 7 is a cross-sectional view of a lighting fixture of a reptile habitat according to an exemplary embodiment of the present invention. Further, FIGS. 8 and 9 are cross-sectional views illustrating a UVA light source according to exemplary embodiments of the present invention. FIG. 10 is a cross-sectional view of a UVB light source according to an exemplary embodiment of the present invention.

Referring to FIG. 4, a reptile habitat 1a includes an enclosure 1010 and a lighting fixture 1020. Further, the reptile habitat 1a may include the control unit (not illustrated), the input unit (not illustrated), at least one sensor 300, and the display unit 70. The lighting fixture 1020 of the reptile habitat 1a may include a UV light source 100, and may further include a visible light source 210, and an IR light source 220.

The lighting system 1 illustrated with reference to FIGS. 1 to 3 may be applied to the reptile habitat 1a. Therefore, repeated description of the of the lighting system 1 will be omitted.

As long as the enclosure 1010 has a predetermined space formed therein, a structure of the enclosure 1010 is not limited. The internal space of the enclosure 1010 may be formed with a habitat, in which the target 50 may live. The enclosure 1010 may include, for example, a water tank, a terrarium, a cage, a tank, or the like. The enclosure 1010 may include materials, such as transparent glass, plastic, and metal, which may visualize the inside of the enclosure 1010 from the outside. In addition, the materials forming the wall of the enclosure 1010 may not transmit irradiated UVA, UVB, and ultraviolet C (UVC; 200 nm to 280 nm) therefrom to the outside, such that irradiated light from the enclosure 1010 may not cause health problems to users. The UVC light may be utilized to sterilize the enclosure 1010. Further, various sculptures may be disposed in the enclosure 1010, and the target 50 such as a reptile may live in the enclosure 1010.

The control unit (not illustrated) may be disposed in the enclosure 1010 or on a surface thereof, and may be connected to the input unit (not illustrated), the display unit 70, the sensor 300, and the lighting fixture 1020. The control unit (not illustrated) may be substantially similar to the control unit of the lighting system 1 illustrated with reference to FIGS. 1 to 3, and thus, repeated description thereof will be omitted.

The display unit 70 may be disposed outside or inside of the enclosure 1010. The display unit 70 may show a current state of the habitat 1a, such as the temperature and the humidity of the habitat 1a, the state of the lighting characteristics of the lighting fixture 1020, or the like. As long as the display unit 70 includes various displays and provides visual information, any display unit may be used without limitation. Further, the display unit 70 may include the input unit (not illustrated). More particularly, the display unit 70 may simultaneously perform input and output functions. For example, the display unit 70 may include a display including a touch panel. The input unit (not illustrated) may alternatively be disposed separately from the display unit 70.

The lighting fixture 1020 may be disposed on the top of the enclosure 1010 to irradiate light into the enclosure 1010. According to an exemplary embodiment of the present invention, the lighting fixture 1020 may serve as a cover for covering the top of the enclosure 1010. The cover of the enclosure 1010 may allow circulation of air via bending ducts formed therein, however, may prevent emitted UV lights from passing therethrough to the outside. A disposition position of the lighting fixture 1020 is not limited to the top of the enclosure 1010. In particular, a position of the lighting fixture 1020 may be varied, as long as the lighting fixture 1020 may irradiate light into the enclosure 1010.

The lighting fixture 1020 includes the UV light source 100 that includes the UVA light source 110 and the UVB light source 120. The lighting fixture 1020 may further include at least one of the visible light source 210, the IR light source 220, and at least one sensor 300.

Referring to FIG. 5, the lighting fixture 1020 may include UVA light sources 110. The UVA light sources 110 may be disposed at an approximately constant interval with each other and irradiate approximately uniform UVA light into the enclosure 1010. The UVA light sources 110 may include first to fourth UVA light sources that each emit UVA light having different wavelengths from one another. For example, wavelength ranges of the UVA light may be substantially similar to those of the UVA light sources illustrated with reference to FIG. 2. According to an exemplary embodiment of the present invention, at least one of the UVA light sources 110 may include multiple lighting elements.

UVA light emitted from the lighting fixture 1020 may be sensed by at least one sensor 300. A UVA sensor sensing UVA light emitted from the UVA light source 110 may be positioned on a lower surface of the lighting fixture 1020, and may also be positioned in the enclosure 1010. For example, as illustrated in FIG. 4, the sensor 300 including the UVA sensor may be additionally disposed on the sculpture positioned in the enclosure 1010.

Referring to FIG. 6, the lighting fixture 1020 may further include a reflector 1021. The reflector 1021 may be disposed at a bottom portion of at least one UVA light source 110, to disperse and reflect UVA light emitted from the UVA light source 110, thereby uniformly irradiating the UVA light in the enclosure 1010. For example, the reflector 1021 may have a structure, in which a top portion thereof have an inclined surface, such that a directional angle of light reflected from the reflector 1021 may be wide. A shape of a top surface of the reflector 1021 may alternatively have, for example, a conical shape. However, as long as the reflector 1021 may reflect and disperse light emitted from the UVA light source 110, the structure of the reflector 1021 is not limited.

Referring to FIG. 7, the lighting fixture 1020 may include multiple UVA light sources 111, 112, 113, and 114. The lighting fixture 1020 may include first to fourth UVA light sources 111, 112, 113, and 114. Further, the reptile habitat 1a may include first to fourth UVA sensors 311, 312, 313, and 314 that sense UVA light emitted from each of the first to fourth UVA light sources 111, 112, 113, and 114. The first to fourth UVA sensors 311, 312, 313, and 314 may each sense lighting characteristics of the UVA light emitted from the corresponding UVA light sources 111, 112, 113, and 114. Functions and operations of the UVA light sources 111, 112, 113, and 114 and the UVA sensors 311, 312, 313, and 314 are substantially similar to those illustrated with reference to FIG. 2, and thus, repeated description thereof will be omitted.

Referring to FIG. 8, at least one UVA light source 110 may include lighting elements 115a, 115b, and 115c. The UVA light source 110 may further include sensor elements 315a, 315b, and 315c that sense light emitted from the lighting elements 115a, 115b, and 115c. The UVA light source 110 may include the first to third lighting elements 115a, 115b, and 115c, and the light emitted from each of the first to third lighting elements 115a, 115b, and 115c may be sensed by the first to third sensor elements 315a, 315b, and 315c. The first to third sensor elements 315a, 315b, and 315c may be disposed in the UVA light source 110, but are not limited thereto. Functions and operations of the lighting elements 115a, 115b, and 115c and the sensor elements 315a, 315b, and 315c may be substantially similar to those illustrated with reference to FIG. 3, and thus, repeated description thereof will be omitted.

Referring to FIG. 9, at least one UVA light source 110 may include multiple UVA light emitting diodes LED1 to LEDn. Peak wavelengths of the first UV light emitting diode LED1 to the n-th UV light emitting diode LEDn may have approximately a constant difference. The first UV light emitting diode LED1 to the n-th UV light emitting diode LEDn may be disposed along a direction in which a light emitting unit 215a extends. The first UV light emitting diode LED1 to the n-th UV light emitting diode LEDn are substantially arranged in a row. The first UV light emitting diode LED1 to the n-th UV light emitting diode LEDn may be alternatively arranged in at least two rows. Further, the UVA light source 110 may include the UVA sensor 310.

Referring to FIG. 10, a UVB light source 120 emits UVB light and may control a direction of irradiated UVB light towards a specific portion. The UVB light source 120 may have a structure that may change a direction of irradiated UVB light, depending on the position of the target 50. For example, the UVB light source 120 may be rotated and/or move vertically and horizontally. More particularly, the UVB light source 120 may include at least one UVB light emitting diode 1201, an operation unit 1204, a cover 1202, and a light guide 1203. The light guide 1203 may have a structure capable of directing a path of light emitted from the UVB light source 120 towards a specific portion. For example, the light guide 1203 may have a cone shape. The UVB light emitting diode 1201 is disposed inside the light guide 1203 and light emitted from the UVB light emitting diode 1201 may be reflected from an inner side wall of the light guide 1203 to be emitted to the outside, through the bottom portion of the light guide 1203. The cover 1202 covers the UVB light emitting diodes 1201. The operation unit 1204 may be positioned at the top portion of the light guide 1203, which may allow the UVB light source 120 to be tilted or rotated. The UVB light emitting diode 1201 may further include a UVB sensor 320 disposed on the inner side wall of the light guide 1203.

Referring back to FIGS. 4 to 7, the visible light source 210 may irradiate visible light into the enclosure 1010. Further, the IR light source 220 may irradiate infrared light into the enclosure 1010, and thus, the internal temperature of the enclosure 1010 may be controlled. The disposition of the visible light source 210 and the IR light source 220 may be varied.

The sensor 300 senses at least some of the light emitted from the light sources 100, 210, and 220. Further, the sensor 300 may sense the position of the target 50. Further, the sensor 300 may sense environmental conditions, such as temperature and humidity of the habitat. The sensor 300 may be positioned in the enclosure 1010 and may also be disposed on the surface of the lighting fixture 1020 or in the lighting fixture 1020.

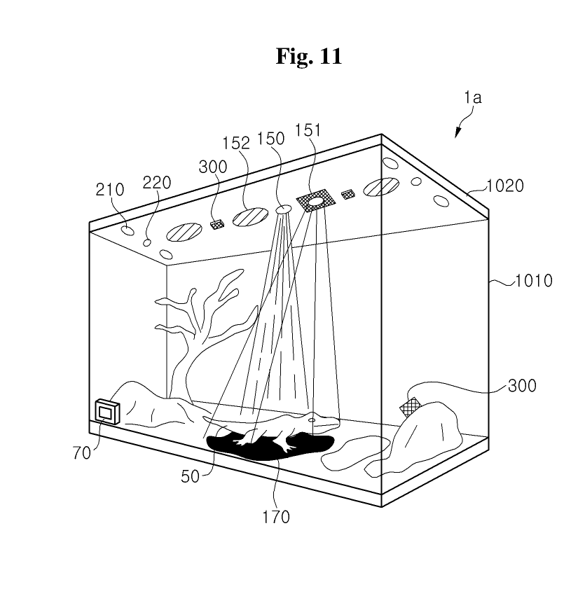

Referring to FIG. 11, according to an exemplary embodiment of the present invention, the location of the reptile may be predicted by providing a reptile basking area that includes, for example, a basking platform 170 with infrared (IR) light 150 radiating the platform area. IR light is configured to emit a collimated focused radiation having a light beam diameter substantially similar to that of the basking area or to that of a target reptile. Heated basking platform may be equipped with the weight measurement sensor to detect the presence of the reptile over platform. As shown in FIG. 11, both IR radiation 150 and UVB or UVC radiation 151 are directed towards platform, and UVB, UVC, or both may be activated when reptile is present on the platform. It is contemplated that the duration and intensity of UVB and UVC may be adjusted according to the residence time of the reptile over the basking area. The statistical data may be collected for reptile residency time over the basking area, to improve control of the UVB and UVC sources. The display unit 70 may show an operating status of various light sources, and the type of lights being emitted, which may be displayed in different colors on the display unit 70. As previously discussed, the habitat may be equipped with ambient UVA sources 152 that diffusively illuminate surroundings of the habitat to improve navigation of the reptile in the habitat and to match reptile's living condition in nature.

Exemplary embodiments of the present invention provide a lighting system for reptiles and the reptile habitat including the same. The lighting system or the habitat according to the exemplary embodiments may also be applied to the lighting system for other kinds of animals, for example, amphibians, an amphibian habitat, or the like. The lighting system for reptiles and the reptile habitat including the same according to the exemplary embodiments may also be used for phototherapy of various kinds of animals in addition to the reptiles. For example, by using the lighting system or the habitat according to the exemplary embodiments, the phototherapy may be applied to animals having symptoms of myospasm, convulsion, trophedema, growth failure, fertility failure, anorexia, digestion disorder, opportunistic infection, or the like due to the deficiency of ultraviolet exposure.

Although certain exemplary embodiments and implementations have been described herein, other embodiments and modifications will be apparent from this description. Accordingly, the inventive concept is not limited to such exemplary embodiments, but rather to the broader scope of the presented claims and various obvious modifications and equivalent arrangements.

What is claimed is:

1. A lighting system, comprising:
an ultraviolet (UV) light source, comprising:
a UVA light source configured to emit UVA light having various wavelengths; and
a UVB light source configured to emit UVB light and control a lighting direction of the UVB light towards a target;
a sensor comprising a UVA sensor configured to sense the UVA light; and
a control unit configured to control lighting characteristics of the UV light source,
wherein the lighting characteristics comprise an intensity of the UVA light.

2. The lighting system of claim 1, wherein the UVA sensor comprises UVA sensor elements configured to sense wavelengths of the UVA light having various wavelengths.

3. The lighting system of claim 1, wherein the lighting characteristics further comprise at least one of a wavelength of emitted light, lighting intensity depending on the wavelength, lighting spectrum of light, and irradiation time.

4. The lighting system of claim 1, further comprising:
an input unit configured to input a command to the control unit.

5. The lighting system of claim 1, further comprising:
at least one of a visible light source and an infrared (IR) light source configured to be controlled by the control unit.

6. The lighting system of claim 1, wherein the control unit is configured to inform a user of a defect in the UVA light source based on the UVA light sensed by the UVA sensor.

7. The lighting system of claim 1, wherein the control unit is configured to control the lighting characteristics of the UV light source depending on the target.

8. The lighting system of claim 1, wherein the UVA light source comprises lighting elements configured to emit the UVA light having various wavelengths.

9. A habitat, comprising:
an enclosure;
a lighting fixture configured to irradiate light to an internal space of the enclosure;
a sensor; and
a control unit,
wherein the lighting fixture comprises an ultraviolet (UV) light source, the UV light source comprising:
a UVA light source comprising lighting elements configured to emit UVA light having various wavelengths; and
a UVB light source configured to emit UVB light and control a lighting direction of the UVB light towards a target,
wherein:
the sensor comprises a UVA sensor configured to sense the UVA light; and
the control unit is configured to control lighting characteristics of the UV light source, the lighting characteristics comprising an intensity of the UVA light emitted from the lighting elements.

10. The habitat of claim 9, wherein the UVA sensor comprises UVA sensor elements configured to sense wavelengths of corresponding lighting elements.

11. The habitat of claim 9, wherein the lighting fixture further comprises at least one of a visible light source and an infrared (IR) light source configured to be controlled by the control unit.

12. The habitat of claim 9, further comprising:
an input unit configured to input a command to the control unit.

13. The habitat of claim 9, wherein the control unit is configured to inform a user a defect in the UVA light source based on the UVA light sensed by the UVA sensor.

14. The habitat of claim 9, wherein the lighting fixture further comprises a reflector configured to disperse the light emitted from the UVA light source.

15. The habitat of claim 9, wherein the UVA sensor is disposed within the enclosure.

16. The habitat of claim 9, wherein the enclosure is configured to prevent the emitted UVA light and the UVB light from passing therethrough to the outside of the enclosure.

17. The habitat of claim 9, further comprising:
a cover comprising bending ducts through which air is circulated,
wherein the emitted UVA light and the UVB light do not pass through the cover to the outside.

18. A lighting system for irradiating reptile habitat, comprising:
a multi-wavelength ultraviolet (UV) light source comprising:
UVA light sources each comprising at least one lighting element configured to emit UVA light having a wavelength greater than 330 nm;
UVB light sources configured to emit UVB light and control a lighting direction of the UVB light towards a target;
UVC light sources configured to irradiate UVC light towards surfaces of the reptile habitat; and
a control unit configured to control lighting characteristics of the multi-wavelength UV light source,
wherein:
the lighting characteristics of the multi-wavelength UV light source comprise increasing or decreasing lighting intensity of the UVA, UVB, and UVC lights;
decreasing lighting intensity comprises turning off one or more of the UVA, UVB, and UVC light sources; and
the intensity of UVC light and direction is selected and controlled not to induce damage to the reptiles present in the reptile habitat.

19. The lighting system for irradiating reptile habitat of claim 18, further comprising:
infrared light sources configured to emit infrared light to reptile basking areas,
wherein the infrared light sources, the UVB light sources, and the UVC light sources are configured to emit light towards the reptile basking areas.

20. The lighting system for irradiating reptile habitat of claim 18, wherein the UVB and UVC light sources are configured to emit a collimated light having a beam diameter that is substantially similar to the largest dimension of the target.

21. The lighting system for irradiating reptile habitat of claim 19, wherein the infrared sources are configured to emit a collimated light having a beam diameter that is substantially similar to the largest dimension of the target or the largest dimension of a basking area.

22. The lighting system for irradiating reptile habitat of claim 19, further comprising:
a weight measurement sensor disposed in a basking area,
wherein the weight measurement sensor is configured to detect the presence of the target and activate the UVB or UVC light sources when reptile is detected in the basking area.

23. The lighting system for irradiating reptile habitat of claim 18, further comprising:
an indicator configured to show an operating status of the UVA, UVB, and UVC light sources.
